(19) United States
(12) Patent Application Publication
(10) Pub. No.: US 2010/0040869 A1
(43) Pub. Date: Feb. 18, 2010

(54) TRANSPARENT CONDUCTIVE FILM AND METHOD FOR MANUFACTURING THE SAME

(75) Inventors: Shin-Liang Kuo, Taipei (TW); Shu-Jiuan Huang, Taipei (TW); Chih-Ming Hu, Kaohsiung (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/419,562

(22) Filed: Apr. 7, 2009

(30) Foreign Application Priority Data
Aug. 12, 2008 (TW) 097130658

(51) Int. Cl. B32B 9/04; B32B 17/06; B32B 19/04; B05D 5/12

(52) U.S. Cl. 428/332; 428/688; 428/426; 428/339; 428/702; 428/454; 428/446; 427/122

(57) ABSTRACT

The disclosed is a transparent conductive film and method for manufacturing the same. First, a substrate is provided. Subsequently, an inorganic layer composed of nano-inorganic compound is formed overlying the substrate. A carbon nanotube dispersion is then coated on the inorganic layer and dried to form a carbon nanotube conductive layer.

### CROSS REFERENCE TO RELATED APPLICATIONS

This Application claims priority of Taiwan Patent Application No. 97130658, filed on Aug. 12, 2008, the entirety of which is incorporated by reference herein.

### BACKGROUND OF THE INVENTION

1. Field of the Invention

The present invention relates to a transparent conductive film, and in particular relates to the method and structure for improving conductance of transparent conductive films.

2. Description of the Related Art

The carbon nanotube, disclosed by Ijima in 1991, was a very important disclosure due to the individual physical and chemical properties of the carbon nanotube, which can be applied to electromagnetic wave shield and static dissipative additive, adsorption material, and energy storage device (e.g. lithium secondary battery, super capacitor, and fuel cell). Additionally, due to increasing cost of ITO transparent conductive oxide, limitation on manufacture of large-scale conductive film, and development of flexible electronics, high conductivity, low absorption of visible light, and high mechanical properties make carbon nanotube a potential candidate for transparent conductive film. Forecast industry size of the carbon nanotube industry is about tens million dollars. However, conductance of conventional carbon nanotube transparent conductive films is determined by inherency, dispersibility, and morphology of CNT network structure. Specifically, differently prepared and structured carbon nanotubes have very different electrical properties, such that the conductivities therebetween may differ. For film with better conductance, single walled carbon nanotubes with high purity are required. In addition to the selection and purification of the carbon nanotube, the conductance of the carbon nanotube film can be enhanced by surface modification by SOCl₂ or Br₂. However, the described chemical modifiers are toxic and not suitable for mass production.

The carbon nanotube based transparent conductive films typically comprises single layered conductive layer. In addition to the carbon nanotube, the conductive layer may further include polymer resins, conductive metal oxides, or other substances. There are no specific designs for conductive films. In U.S. Pat. No. 5,098,771, carbon nano fiber is applied as a conductive paint and conductive ink. The formula includes carbon nano fibers and polymer binder is sprayed to form a conductive film. In U.S. Pat. No. 5,853,877, a transparent conductive film is prepared from acidified carbon nanotubes. The acidified carbon nanotube is added to polar solvent to form a dispersion. The dispersion is added a polymer dispersant or binder, and then spin-coated to form a transparent conductive film. In U.S. Pat. No. 5,908,585, the composition of coating solution for the transparent conductive film will be emphasized. 0.01˜10% carbon nanotube and 1˜40% transparent conductive oxides such as antimony doped tin oxide were selected to prepare the dispersion. The dispersion was then added resin or gel to form a conductive coating formula. In U.S. Pat. No. 7,060,241, single walled carbon nanotube with a specific tube diameter (less than 3.5 nm) was selected to be raw material for forming a film with better conductance and transparency. In Japan Patent No. 2005336341, the composite of carbon nanotube and conductive polymer served to be conductive layer material. Other patents associated with carbon nanotube transparent conductive film focus on the polymer binder composition and methods for forming a film.

Accordingly, a novel transparent conductive film structure and composition for improving the conductance of the original single layered carbon nanotube conductive film is called for.

### BRIEF SUMMARY OF THE INVENTION

The invention provides a transparent conductive film, comprising a substrate, an inorganic layer formed on the substrate, and the inorganic is composed of nano-inorganic compound; and a carbon nanotube conductive layer formed on the inorganic layer.

The invention also provides a method for forming a transparent conductive film, comprising: providing a substrate; forming an inorganic layer on the substrate, wherein the inorganic layer is composed of a nano-inorganic compound; coating a carbon nanotube dispersion on the inorganic layer; and drying the carbon nanotube dispersion to form a carbon naonotube conductive layer.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1-2 are cross sections showing the flow of forming a transparent conductive film structure in embodiments of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

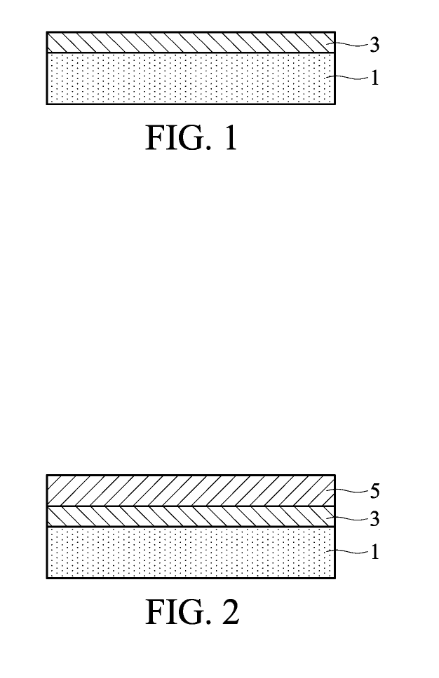

As shown in FIG. 1, an inorganic layer 3 is formed on a substrate 1. The material selection of the substrate 1 includes inorganic compound such as glass or organic compound such as plastic or synthetic resin. The plastic can be poly(ethylene terephthalate) (PET), polyethylene (PE), polypropylene (PP), polycarbonate (PC), polystyrene (PS), acrylonitrile-butadiene-styrene copolymer (ABS), or other general plastics. The synthetic resin includes novolac resin, urea formaldehyde resin, unsaturated polyester resin, melamine resin, polyurethane resin, alkyd resin, epoxy resin, polyvinyl acetate resin, petroleum resin, polyamide resin, furan resin, maleic anhydride resin, and the likes.

The inorganic layer 3 is composed of nano-inorganic compound having at least one dimension (length, width, and/or thickness) of 0.5 nm to 100 nm. The nano-inorganic compound can be oxide, silicate, hydroxide, carbonate, sulfate, phosphate, sulfide, or combinations thereof. The suitable oxide includes silicon oxide, tin oxide, titanium oxide, zinc oxide, aluminum oxide, zirconium oxide, indium oxide, antimony oxide, tungsten oxide, yttrium oxide, magnesium oxide, cerium oxide, doped oxides thereof, or combinations thereof. The silicate includes silica alumina clay, vermiculite, tubular kaolin, sericite, bentonite, mica, or combinations thereof. The method for forming the inorganic layer 3 can be by a wet process such as coating or dry process such as deposition or sputtering. In one embodiment, the inorganic layer 3 adopts a metal oxide such as titanium oxide or tin oxide, such that the solution containing nano metal oxides with a size of about 10 nm can be formed by a sol-gel method. Thereafter, the solution is coated on the substrate 1 by wire bar and then dried to form the inorganic layer 3. In another embodiment, a commercially available nano-scaled silicon dioxide or clay is dispersed in methyl ethyl ketone (MEK) or water to prepare the dispersion. The dispersion is coated on the substrate 1 and then dried to form the inorganic layer 3.

Subsequently, a carbon nanotube dispersion is prepared. The dispersion is basically composed of carbon nanotube, dispersant, and water.

The carbon nanotube includes a single walled carbon nanotube, multi walled carbon nanotube, or combinations thereof. The carbon nanotube has a tube diameter of 0.7 nm to 100 nm.

The dispersant is utilized to avoid aggregation of the carbon nanotube, such that the carbon nanotube is uniformly dispersed in water. The dispersant is a typical surfactant such as an anionic surfactant, cationic surfactant, nonionic surfactant, zwitterionic surfactant, or combinations thereof.

A suitable anionic surfactant can be sodium salt, magnesium salt, or ammonium salt of alkyl sulphates, alkyl ether sulphates, alkaryl sulphonates, alkanoyl isethionates, alkyl succinates, alkyl sulphosuccinates, N-alkoxyl sarcosinates, alkyl phosphates, alkyl ether phosphates, alkyl ether carboxylates or alpha-olefin sulphonates.

A suitable nonionic surfactant can be an aliphatic (C₈₋₁₈) primary or secondary linear or branched alcohol or phenol accompanied with an alkylene oxide. In one embodiment, the alkylene oxide is composed of 6 to 30 ethylene oxides. Other nonionic surfactant like alkanolamides can be substituted by one or two alkyl groups, such as coco ethanolamide, coco di-ethanolamide, coco isopropanolamide, or the likes.

The described zwitterionic surfactant can be alkyl amine oxides, alkyl betaines, alkyl amidopropyl betaines, alkyl sulphobetaines, alkyl sulphobetaines, alkyl glycinates, alkyl carboxyglycinates, alkyl amphopropionates, alkyl amphoglycinates, alkyl amidopropyl hydroxysultainates, acyl taurates, or acyl glutamates. The described alkyl can be a C₈₋₁₉ alkyl group. For example, the zwitterionic surfactant also includes lauryl amine oxide, cocodimethyl sulphopropyl betaine, lauryl betaine, cocamidopropyl betaine, or sodium cocamphopropionate.

In one embodiment, the carbon naotube dispersion may further include a nano-inorganic compound similar to the inorganic layer 3, a polymer, a binder, or combinations thereof. As such, the mechanical properties such as adhesion between the carbon nanotube conductive layer and the inorganic layer 3 can be enhanced to prevent product lamination due to external strike or compression.

Lastly, the carbon nanotube dispersion is coated on the inorganic layer 3, and then dried to form the carbon nanotube conductive layer 5 as shown in FIG. 2. The coating step can be continued for multiple of times to form thicker carbon nanotube conductive layers 5. It is understood that thicker carbon nanotube conductive layer 5 has better conductance but lower transparency. On the other hand, the thinner carbon nanotube conductive layer 5 has worse conductance but higher transparency. In related art, the thicker carbon nanotube layer is adopted to enhance conductance, thereby sacrificing transparency thereof. The transparent inorganic layer 3 is disposed between the substrate 1 and the carbon nanotube conductive layer 5, thereby efficiently improving conductance of the carbon nanotube conductive layer 5. Accordingly, it is not necessary to increase the carbon nanotube conductive layer 5 thickness for sufficient conductance, thereby simultaneously achieving conductance and transparency.

### EXAMPLES

### Example 1

SiO₂ sol dispersed in MEK (4730S, commercially available from Changchun Chemical) was coated on a PET film (A4100, commercially available from Toyobo) by a wire bar, and then dried to form an inorganic layer on the PET film.

Subsequently, 0.02 g of single walled carbon nanotube (ASP-100F, commercially available from Ijin) and 0.02 g of sodium dodecylbenzenesulfonate (commercially available from Fluka) were added to 10.0 g of water, and ultrasonic vibrated to form a carbon nanotube dispersion. The dispersion was coated on the inorganic layer by a wire bar and then dried to form a carbon nanotube conductive layer. As such, the transparent conductive film was completed.

The transparency of the transparent conductive film was measured with a 550 nm wavelength light as the standard. The transparency sum of the PET film and the inorganic layer was considered as background value. The transparency of the transparent conductive film was 95.1% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of 1.4*10³Ω/□.

### Example 2

Similar to Example 1, the difference in Example 2 was that the inorganic solution composed of antimony-doped tin oxide (Sb:SnO₂) was prepared by a sol-gel method. For the sol-gel method, please refer to experiments in J. Electrochem. Soc., 148, A550 (2001). 1.0 g of the inorganic solution was coated on the PET film (A4100, commercially available from Toyobo) by a wire bar and then dried to form an inorganic layer on the PET film.

Subsequently, the carbon nanotube dispersion of Example 1 was coated on the inorganic layer by a wire bar and then dried to form a carbon nanotube conductive layer. As such, the transparent conductive film was completed.

The measurements of transparency and sheet resistance of the transparent conductive film were similar to those of Example 1. The transparent conductive film had a transparency of 95.1% (without the background value) and a sheet resistance of 1.5*10³Ω/□.

### Example 3

Similar to Example 1, the difference in Example 3 was that the inorganic solution composed of titanium oxide (TiO₂) was prepared by a sol-gel method. For the sol-gel method, please refer to Japan patent No. 2001104797. 1.0 g of the inorganic solution was coated on the PET film (A4100, commercially available from Toyobo) by a wire bar and then dried to form an inorganic layer on the PET film.

Subsequently, the carbon nanotube dispersion of Example 1 was coated on the inorganic layer by a wire bar and then dried to form a carbon nanotube conductive layer. As such, the transparent conductive film was completed.

The measurements of transparency and sheet resistance of the transparent conductive film were similar to those of Example 1. The transparent conductive film had a transparency of 94.0% (without the background value) and a sheet resistance of 1.7*10³Ω/□.

### Example 4

Similar to Example 1, the difference in Example 4 was that the inorganic solution was clay dispersion (SWN, commercially available from CO-OP). 1.0 g of the inorganic solution was coated on the PET film (A4100, commercially available from Toyobo) by a wire bar and then dried to form an inorganic layer on the PET film.

Subsequently, the carbon nanotube dispersion of Example 1 was coated on the inorganic layer by a wire bar and then dried to form a carbon nanotube conductive layer. As such, the transparent conductive film was completed.

The measurements of transparency and sheet resistance of the transparent conductive film were similar to those of Example 1. The transparent conductive film had a transparency of 96.6% (without the background value) and a sheet resistance of 2.5*10³Ω/□.

### Example 5

Similar to Example 1, the difference in Example 5 was that the carbon nanotube dispersion was added 0.3 g of silicon dioxide sol (Besil-30A, commercially available from A-Green Co. Ltd).

1.0 g of the inorganic solution of Example 1 was coated on the PET film (A4100, commercially available from Toyobo) by a wire bar and then dried to form an inorganic layer on the PET film.

Subsequently, the carbon nanotube dispersion with silicon dioxide sol was coated on the inorganic layer by a wire bar and then dried to form a carbon nanotube conductive layer. As such, the transparent conductive film was completed.

The measurements of transparency and sheet resistance of the transparent conductive film were similar to those of Example 1. The transparent conductive film had a transparency of 93.5% (without the background value) and a sheet resistance of 1.2*10³Ω/□.

### Comparative Example 1

The carbon nanotube dispersion of Example 1 was directly coated on the PET film (A4100, commercially available from Toyobo) by a wire bar, and then dried to form a carbon nanotube conductive layer. The difference between Comparative Example 1 and Example 1 was that no inorganic layer was disposed between the substrate and the carbon nanotube conductive layer in Comparative Example 1.

The transparency of the transparent conductive film was measured with a 550 nm wavelength light as the standard. The transparency PET film layer was considered as background value. The transparency of the transparent conductive film was 94.7% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of 7.0*10³Ω/□.

As shown when comparing Examples 1-5 and Comparative Example 1, the transparent conductive film including the inorganic layer showed better conductance. The Examples 1-5, were 3 to 6 times the conductance of the Comparative Example 1, without sacrificing the transparency.

### Example 6

1.0 g of SiO₂ sol dispersed in MEK (4730S, commercially available from Changchun Chemical) was coated on a PET film (A4100, commercially available from Toyobo) by a wire bar, and then dried to form an inorganic layer on the PET film.

Subsequently, 0.05 g of multi walled carbon nanotube (Nanocyl-7000, commercially available from Nanocyl) and 0.05 g of sodium dodecylbenzenesulfonate (commercially available from Fluka) were added to 10.0 g of water, and ultrasonic vibrated to form a carbon nanotube dispersion. The dispersion was coated on the inorganic layer by a wire bar and then dried to form a carbon nanotube conductive layer. As such, the transparent conductive film was completed.

The transparency of the transparent conductive film was measured with a 550 nm wavelength light as the standard. The transparency sum of the PET film and the inorganic layer was considered as background value. The transparency of the transparent conductive film was 88.0% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of 1.0*10⁴Ω/□.

### Example 7

Similar to Example 6, the difference in Example 7 was that the inorganic solution was clay dispersion (SWN, commercially available from CO-OP). 1.0 g of the inorganic solution was coated on the PET film (A4100, commercially available from Toyobo) by a wire bar and then dried to form an inorganic layer on the PET film.

Subsequently, the carbon nanotube dispersion of Example 6 was coated on the inorganic layer by a wire bar and then dried to form a carbon nanotube conductive layer. As such, the transparent conductive film was completed.

The measurements of transparency and sheet resistance of the transparent conductive film were similar to those of Example 6. The transparent conductive film had a transparency of 89.5% (without the background value) and a sheet resistance of 2.4*10⁴Ω/□.

### Example 8

Similar to Example 6, the difference in Example 8 was that the inorganic solution composed of titanium oxide (TiO₂) was prepared by a sol-gel method. For the sol-gel method, please refer to Japan patent No. 2001104797. 1.0 g of the inorganic solution was coated on the PET film (A4100, commercially available from Toyobo) by a wire bar and then dried to form an inorganic layer on the PET film.

Subsequently, the carbon nanotube dispersion of Example 6 was coated on the inorganic layer by a wire bar and then dried to form a carbon nanotube conductive layer. As such, the transparent conductive film was completed.

The measurements of transparency and sheet resistance of the transparent conductive film were similar to those of Example 6. The transparent conductive film had a transparency of 89.9% (without the background value) and a sheet resistance of 1.9*10⁴Ω/□.

### Comparative Example 2

The carbon nanotube dispersion of Example 6 was directly coated on the PET film (A4100, commercially available from Toyobo) by a wire bar, and then dried to form a carbon nanotube conductive layer. The difference between Comparative Example 2 and Example 6 was that no inorganic layer was disposed between the substrate and the carbon nanotube conductive layer in Comparative Example 2.

The transparency of the transparent conductive film was measured with a 550 nm wavelength light as the standard. The transparency PET film layer was considered as background value. The transparency of the transparent conductive film was 89.4% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of 5.6*10⁴Ω/□.

As shown when comparing Examples 6-8 and Comparative Example 2, the transparent conductive film including the inorganic layer had better conductance. Examples 6-8 showed 3 to 6 times the conductance of the Comparative Example 2, without sacrificing transparency.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transparent conductive film, comprising:
a substrate;
an inorganic layer formed on the substrate, wherein the inorganic layer is composed of a nano-inorganic compound; and
a carbon nanotube conductive layer formed on the inorganic layer.

2. The transparent conductive film as claimed in claim 1, wherein the substrate comprises glass, plastic, or synthetic resin.

3. The transparent conductive film as claimed in claim 1, wherein the nano-inorganic compound has at least one dimension of 0.5 nm to 100 nm.

4. The transparent conductive film as claimed in claim 1, wherein the nano-inorganic compound comprises oxide, silicate, hydroxide, carbonate, sulfate, phosphate, sulfide, or combinations thereof.

5. The transparent conductive film as claimed in claim 4, wherein the oxide comprises silicon oxide, tin oxide, titanium oxide, zinc oxide, aluminum oxide, zirconium oxide, indium oxide, antimony oxide, tungsten oxide, yttrium oxide, magnesium oxide, cerium oxide, doped oxides thereof, or combinations thereof.

6. The transparent conductive film as claimed in claim 4, wherein the silicate comprises silica alumina clay, vermiculite, tubular kaolin, sericite, bentonite, mica, or combinations thereof.

7. The transparent conductive film as claimed in claim 1, wherein the carbon nanotube conductive layer comprises single walled carbon nanotube, multi walled carbon nanotube, or combinations thereof.

8. The transparent conductive film as claimed in claim 7, wherein the single walled carbon nanotube or multi walled carbon nanotube has a tube diameter of 0.7 nm to 100 nm.

9. The transparent conductive film as claimed in claim 1, wherein the carbon nanotube conductive layer further comprises the nano-inorganic compound, a polymer, a binder, or combinations thereof.

10. A method for forming a transparent conductive film, comprising:
providing a substrate;
forming an inorganic layer on the substrate, wherein the inorganic layer is composed of a nano-inorganic compound;
coating a carbon nanotube dispersion on the inorganic layer; and
drying the carbon nanotube dispersion to form a carbon naonotube conductive layer.

11. The method as claimed in claim 10, wherein the substrate comprises glass, plastic, or synthetic resin.

12. The method as claimed in claim 10, wherein the step of forming the inorganic layer comprises a coating, deposition, or sputtering process.

13. The method as claimed in claim 10, wherein the nano-inorganic compound has at least one dimension of 0.5 nm to 100 nm.

14. The method as claimed in claim 10, wherein the nano-inorganic compound comprises oxide, silicate, hydroxide, carbonate, sulfate, phosphate, sulfide, or combinations thereof.

15. The method as claimed in claim 14, wherein the oxide comprises silicon oxide, tin oxide, titanium oxide, zinc oxide, aluminum oxide, zirconium oxide, indium oxide, antimony oxide, tungsten oxide, yttrium oxide, magnesium oxide, cerium oxide, doped oxides thereof, or combinations thereof.

16. The method as claimed in claim 14, wherein the silicate comprises silica alumina clay, vermiculite, tubular kaolin, sericite, bentonite, mica, or combinations thereof.

17. The method as claimed in claim 10, wherein the carbon nanotube dispersion comprises carbon nanotube, dispersant, and water.

18. The method as claimed in claim 17, wherein the carbon nanotube comprises single walled carbon nanotube, multi walled carbon nanotube, or combinations thereof.

19. The method as claimed in claim 17, wherein the single walled carbon nanotube or multi walled carbon nanotube has a tube diameter of 0.7 nm to 100 nm.

20. The method as claimed in claim 17, wherein the carbon nanotube dispersion further comprises the nano-inorganic compound, a polymer, a binder, or combinations thereof.
